SEQUENCE LISTING (1 sequence)

SEQ ID NO: 1 - protein, 2050 aa, Artificial Sequence
  Synthetic Polypeptide
SLSCRPPMVKLVCPADNLRAEGLECTKTCQNYDLECMSMGCVSGCLCPPGMVRHENRCVALERCPCFHQGKEYAPGETVKIGCNTCVCRDRKWNCTDHVCDATCSTIGMAHYLTFDGLKYLFPGECQYVLVQDYCGSNPGTFRILVGNKGCSHPSVKCKKRVTILVEGGEIELFDGEVNVKRPMKDETHFEVVESGRYIILLLGKALSVVWDRHLSISVVLKQTYQEKVCGLCGNFDGIQNNDLTSSNLQVEEDPVDFGNSWKVSSQCADTRKVPLDSSPATCHNNIMKQTMVDSSCRILTSDVFQDCNKLVDPEPYLDVCIYDTCSCESIGDCACFCDTIAAYAHVCAQHGKVVTWRTATLCPQSCEERNLRENGYECEWRYNSCAPACQVTCQHPEPLACPVQCVEGCHAHCPPGKILDELLQTCVDPEDCPVCEVAGRRFASGKKVTLNPSDPEHCQICHCDVVNLTCEACQEPGGLVVPPTDAPVSPTTLYVEDISEPPLHDFYCSRLLDLVFLLDGSSRLSEAEFEVLKAFVVDMMERLRISQKWVRVAVVEYHDGSHAYIGLKDRKRPSELRRIASQVKYAGSQVASTSEVLKYTLFQIFSKIDRPEASRITLLLMASQEPQRMSRNFVRYVQGLKKKKVIVIPVGIGPHANLKQIRLIEKQAPENKAFVLSSVDELEQQRDEIVSYLCDLAPEAPPPTLPPDMAQVTVGPGLLGVSTLGPKRNSMVLDVAFVLEGSDKIGEADFNRSKEFMEEVIQRMDVGQDSIHVTVLQYSYMVTVEYPFSEAQSKGDILQRVREIRYQGGNRTNTGLALRYLSDHSFLVSQGDREQAPNLVYMVTGNPASDEIKRLPGDIQVVPIGVGPNANVQELERIGWPNAPILIQDFETLPREAPDLVLQRCCSGEGLQIPTLSPAPDCSQPLDVILLLDGSSSFPASYFDEMKSFAKAFISKANIGPRLTQVSVLQYGSITTIDVPWNVVPEKAHLLSLVDVMQREGGPSQIGDALGFAVRYLTSEMHGARPGASKAVVILVTDVSVDSVDAAADAARSNRVTVFPIGIGDRYDAAQLRILAGPAGDSNVVKLQRIEDLPTMVTLGNSFLHKLCSGFVRICMDEDGNEKRPGDVWTLPDQCHTVTCQPDGQTLLKSHRVNCDRGLRPSCPNSQSPVKVEETCGCRWTCPCVCTGSSTRHIVTFDGQNFKLTGSCSYVLFQNKEQDLEVILHNGACSPGARQGCMKSIEVKHSALSVELHSDMEVTVNGRLVSVPYVGGNMEVNVYGAIMHEVRFNHLGHIFTFTPQNNEFQLQLSPKTFASKTYGLCGICDENGANDFMLRDGTVTTDWKTLVQEWTVQRPGQTCQPILEEQCLVPDSSHCQVLLLPLFAECHKVLAPATFYAICQQDSCHQEQVCEVIASYAHLCRTNGVCVDWRTPDFCAMSCPPSLVYNHCEHGCPRHCDGNVSSCGDHPSEGCFCPPDKVMLEGSCVPEEACTQCIGEDGVQHQFLEAWVPDHQPCQICTCLSGRKVNCTTQPCPTAKAPTCGLCEVARLRQNADQCCPEYECVCDPVSCDLPPVPHCERGLQPTLTNPGECRPNFTCACRKEECKRVSPPSCPPHRLPTLRKTQCCDEYECACNCVNSTVSCPLGYLASTATNDCGCTTTTCLPDKVCVHRSTIYPVGQFWEEGCDVCTCTDMEDAVMGLRVAQCSQKPCEDSCRSGFTYVLHEGECCGRCLPSACEVVTGSPRGDSQSSWKSVGSQWASPENPCLINECVRVKEEVFIQQRNVSCPQLEVPVCPSGFQLSCKTSACCPSCRCERMEACMLNGTVIGPGKTVMIDVCTTCRCMVQVGVISGFKLECRKTTCNPCPLGYKEENNTGECCGRCLPTACTIQLRGGQIMTLKRDETLQDGCDTHFCKVNERGEYFWEKRVTGCPPFDEHKCLAEGGKIMKIPGTCCDTCEEPECNDITARLQYVKVGSCKSEVEVDIHYCQGKCASKAMYSIDINDVQDQCSCCSPTRTEPMQVALHCTNGSVVYHEVLNAMECKCSPRKCSK

(19) United States
(12) Patent Application Publication
(10) Pub. No.: US 2010/0155588 A1
(43) Pub. Date: Jun. 24, 2010

(54) RECOMBINANT VON WILLEBRAND FACTOR AS MOLECULAR WEIGHT MARKER FOR MASS SPECTROMETRY ANALYSES

(75) Inventors: Jasmin Kemptner, Laakirchen (AT); Martina Marchetti-Deschmann, Vienna (AT); Roland Mueller, Baden (AT); Andreas Ivens, Vienna (AT); Peter Turecek, Klosterneuburg (AT); Hans-Peter Schwarz, Vienna (AT); Guenter Allmaier, Vienna (AT)

Correspondence Address: MARSHALL, GERSTEIN & BORUN (BAXTER), 233 SOUTH WACKER DRIVE, 6300 WILLIS TOWER, CHICAGO, IL, 60606-6357, US

(73) Assignees: BAXTER INTERNATIONAL INC., Deerfield, IL (US); BAXTER HEALTHCARE S.A., Glattpark (Opfikon) (CH); TECHNISCHE UNIVERSITAET WIEN, Wien (AT)

(21) Appl. No.: 12/639,619

(22) Filed: Dec. 16, 2009

Related U.S. Application Data
(60) Provisional application No. 61/140,475, filed on Dec. 23, 2008.

(51) Int. Cl. H01J 49/26; B01D 59/44

(52) U.S. Cl. 250/252.1

(57) ABSTRACT

Methods for determining molecular mass of at least 150 kDa of an analyte of interest using MALDI mass spectrometry in combination with a recombinant von Willebrand factor (rVWF) molecular weight marker are disclosed. More specifically, monomeric and multimeric rVWF are used for external and internal calibration of mass spectra applied for analytes having high molecular weights above 150 kDa.

### CROSS REFERENCE TO RELATED APPLICATIONS

This application claims the benefit of U.S. Provisional Application No. 61/140,475, filed Dec. 23, 2008, the disclosure of which is incorporated by reference in its entirety.

### BACKGROUND

Von Willebrand factor (VWF) is an adhesive complex glycoprotein with a molecular mass of the monomer of about 260 kDa (determined by SDS agarose gel electrophoresis¹⁻³), VWF circulating in human plasma as a dimer and oligomers ranging in molecular mass from 450 kDa to 20 000 kDa^{2,4,5}. The precursor polypeptide, pre-pro-VWF, synthesized in endothelial cells^{6,7} and megakaryocytes⁸, consists of a 22-amino acid residue signal peptide, a 741-residue pro-peptide and a 2050-residue polypeptide⁹. After in vivo removal of the signal peptide two pro-VWF units are linked via disulfide bonds forming dimers, the building blocks for mature VWF multimers^{10,11}. Prior to plasma release the pro-peptide is cleaved off and the remaining part contains several post translational modifications, namely glycosylation^{9,12-14} and sulfation¹⁵. The final mature VWF carries 12 N- and 10 O-glycans, whereof specific N-glycans are further modified by sulfation¹⁶.

The carbohydrate moiety contributes to several specific properties of VWF, e.g. physiological activity, receptor binding, clearance from plasma circulation and structural stability^{17,18}. After biosynthesis, mature VWF is either released into the blood circulation system or it is stored in the Weibel-Palade body¹⁹. In human plasma, VWF serves a dual purpose in hemostasis. In case of vascular injury, it mediates adhesion of platelet glycoproteins, e.g. collagen to vascular subendothelium²⁰. Furthermore, VWF builds a non-covalent complex with blood coagulation factor VIII (FVIII) avoiding its rapid clearance from plasma, thus normal thrombin generation can take place²¹.

Inherited defects on VWF cause von Willebrand Disease (VWD), one of the most common bleeding disorders in humans²². Symptoms of VWD are abnormal platelet function leading to constant nose bleeding, unexplained bruising or prolonged bleeding after injury. Due to the reduced level of VWF, VWD is commonly accompanied by a decrease of FVIII procoagulant activity. Depending on the severity of VWF defect, several degrees of VWD occur. Patients with mild VWD have reduced VWF plasma levels and are treated by administration of desmopressin, which temporarily increases the VWF level²³. Patients suffering from more severe forms of VWD have to be treated with human plasma derived concentrates or cryoprecipitates, containing both FVIII and VWF^{24,25}. However, this replacement therapy is accompanied by some limitations²⁶. Human plasma derived VWF concentrates show varying VWF and FVIII levels and ratios, depending on the donor's pool. Furthermore, due to proteolytic degradation during the isolation and purification (manufacturing) process, the multimer composition of the plasma derived VWF concentrates varies and no high molecular mass multimers, exhibiting the highest hemostatical activity, can be found. The use of recombinant VWF (rVWF) produced by fermentation of transformed cells can overcome these limitations²⁷. Absence of plasma proteases avoids rVWF degradation and the risk of virus transmission is nearly eliminated. In vivo and in vitro evaluations have confirmed that structure and properties of rVWF are comparable to plasma derived VWF²⁸.

Molecular weight determination of analytes using mass spectrometry is limited by the availability of standards, i.e., molecules of known exact molecular weight and well-defined composition from batch-to-batch at reasonable costs that can be used to correlate an unknown mass of an analyte to the known mass of the standard. If an analyte has a mass that is significantly outside a range about the mass of a known standard, the accuracy of the correlation is decreased. To date, well-defined protein/glycoprotein standards for use in mass spectrometry analysis of analytes having a molecular weight greater than 100 kDa are limited. Immunoglobulin proteins have been used, but their masses are limited to suitability of analytes having a molecular weight up to about 150 kDa. Thus, a need exists for a molecular weight standard that can be used to determine the molecular weight of analytes having masses greater than, e.g., 200 kDa.

### SUMMARY

Disclosed herein is a method of determining the molecular weight of an analyte using mass spectrometry (MS) by measuring the mass spectrum of the analyte and correlating it to the mass spectrum of a recombinant VWF (rVWF) of known molecular weight. The mass spectrum of the rVWF can be obtained by measuring it directly or by referring to a previously prepared spectrum. The analytes being analyzed in the disclosed methods are those having a high molecular weight (MW; the term molecular mass can be used synonymously), e.g., at least 200 kDa. In some embodiments, the analyte has a MW of at least 1000 kDa or at least 1500 kDa. In specific embodiments, the analyte is an antibody or another large protein such as fibrinogen or collagen or derivatives thereof

In some cases, the method disclosed further comprises calculating the MW of the VWF molecular weight marker by determining the number of monomers of VWF (SEQ ID NO: 1) in VWF molecular weight marker. In various embodiments, the sample and the VWF molecular weight marker are desalted prior to analysis by MS.

### BRIEF DESCRIPTION OF THE FIGURES

FIG. 1 shows CGE-on-the-chip electropherograms of rVWF samples A, B and C under reducing conditions without pre-purification. (FU, fluorescence units, s, seconds in migration time).

FIG. 2 shows an SDS-PAGE image of rVWF sample A under reducing conditions after various desalting procedures.

FIG. 3 shows nano ES GEMMA spectra of rVWF samples A, B and C after reduction of disulfide bridges and desalting with MicroSpin™ devices.

FIG. 4 shows positive ion MALDI mass spectra obtained in the linear mode of rVWF samples A, B and C. M indicates mature rVWF and P indicates pro-rVWF.

### DETAILED DESCRIPTION

As described herein, monomers and multimers of rVWF are used as mass spectrometry molecular weight markers for analytes of high MW because the MWs of multimeric rVWF is easily be calculated based upon the known MW of the repeating rVWF monomers (SEQ ID NO: 1). Thus, knowing the MW of the VWF multimer allows its use to calibrate (i.e., a calibrant) mass spectrometry techniques use to determine the mass of an analyte of interest. The MW of rVWF includes the protein moiety and the glycan moiety of glycosylated rVWF if it is used from a source that produces reproducibly glycosylated VWF.

Due to the ability to prepare high molecular mass rVWF multimers (based upon the number of monomers of VWF), it was discovered that rVWF is useful as a molecular weight marker for mass spectrometry analyses of analytes having high (e.g., greater than 200 kDa) molecular weights. The molecular weight of multimers of VWF is calculated based upon the number of repeating units of the VWF monomer (SEQ ID NO: 1). Depending upon the nature of the analyte to be assessed, a rVWF multimer is prepared having the appropriate mass to be a suitable marker for the analyte of interest, anywhere from 200 kDa to over 5,000 kDa. For example, when an analyte is suspected of having a mass in a specific range, a monomer and one or more ic and/or multimeric forms of rVWF are prepared that have a sufficient number of repeating rVWF monomers to provide a mass within, for example and without limitation, about 10 kDa of the suspected (or expected) mass of the analyte. Then, the spectrum of the analyte is compared to the spectrum of the rVWF marker or markers to provide a mass for the analyte. One benefit of using rVWF as a standard for mass spectrometry analysis is that the rVWF standard used does not have to contain only one multimer. Due to the repeating mass units of the rVWF monomers, even a mixture of different multimers is useful because their masses are evenly spaced by the mass of the VWF monomer or dimer.

The monomer, dimer and multimers of rVWF are typically connected using disulfide bonds.

VWF can be used as a standard, alternatively referred to herein as a molecular weight marker, for analytes having a molecular weight of at least 200 kDa, at least 250 kDa, at least 300 kDa, at least 350 kDa, at least 400 kDa, at least 450 kDa, at least 500 kDa, at least 550 kDa, at least 600 kDa, at least 650 kDa, at least 700 kDa, at least 750 kDa, at least 800 kDa, at least 850 kDa, at least 900 kDa, at least 950 kDa, at least 1000 kDa, at least 1100 kDa, at least 1200 kDa, at least 1250 kDa, at least 1300 kDa, at least 1350 kDa, at least 1400 kDa, at least 1450 kDa, at least 1500 kDa, or at least 2000 kDa.

Preparation of a rVWF having a desired molecular weight can be achieved by expression from mammalian cells and had been described in the literature (Fischer, Thromb Thrombolysis, 8(3):197-205, 1999, Schwarz, et al., Semin Thromb Hemost, 28(2):215-26, 2002, Turecek, et al., Histochem Cell Biol., 117:123-129, 2002, Cytotechnology. 30(1-3):1-16, 1999)

Nano ES (electrospray) gas phase electrophoretic mobility macromolecular analyzer (GEMMA), a particular kind of ion mobility spectrometer, vacuum matrix-assisted laser desorption ionization (MALDI) mass spectrometry (MS) and additionally capillary gel electrophoresis-on-the-chip (CGE-on-the-chip) can be used to determine the molecular weight of an analyte. Contrary to the commonly used approach, SDS-polyacrylamide²⁹ and -agarose gel electrophoresis³⁰, determination of the exact molecular size, sample heterogeneity and exact molecular mass of three rVWF preparations was performed by nano ES GEMMA, MALDI-linear TOF (time-of-flight) MS as well as CGE-on-the-chip.

Nano ES GEMMA analysis is based on generating multiply charged molecular ions by means of a nano ES process in the cone-jet mode followed by charge reduction via polonium-210, thus yielding neutral and singly charged positive and negative ions. These ions are size separated according to their electrophoretic mobility diameter (EMD) using a nano differential mobility analyzer (nDMA) and detected by means of a condensation particle counter (μCPC) based on an indirect optical detection³¹⁻³³. Based on the correlation (r=0.998) of the EMD to the molecular mass of well defined globular proteins, the molecular mass of glycoproteins can be determined³⁴. GEMMA analysis is generally discussed in Allmaier, et al., J. Mass. Spec., 36:1038-1052 (2001).

The second method used for characterization of rVWF was positive ion MALDI MS applying a linear TOF system with a standard detector³⁵. The well-established “soft” desorption/ionization technique MALDI generating mainly singly to triply charged molecular ions, showing a high salt and detergent tolerance and requiring low amounts of samples, makes MALDI TOF MS to the dedicated technique for accurate molecular mass determination of intact high mass proteins³⁶. Discussion of MALDI can be found in U.S. Pat. No. 7,351,959, incorporated herein by reference.

### EXAMPLES

### Chemicals

Ammonium acetate p.a., acetic acid 96%, acetonitrile p.a. (ACN), methanol p.a. (MeOH), formic acid 98-100% (FA) and water p.a. (conductivity at 25° C.≦1 μS/cm) were purchased from Merck (Darmstadt, Germany). Coomassie Brilliant Blue R250 (CBB), sodium dodecyl sulphate (SDS) and 2,4,6 trihydroxyacetophenone monohydrate (THAP) were obtained from Fluka (Buchs, Switzerland). Lithium dodecyl sulphate (LDS) and 1,4-dithiothreitol (DTT, min 99.0%) were obtained from Sigma-Aldrich (Steinheim, Germany). NuPage LDS sample buffer (4×), NuPage Tris-Acetate SDS running buffer (20×), HiMark unstained high molecular weight protein standard and Invitromass high molecular weight mass calibration kit were purchased from Invitrogen (Carlsbad, Calif., USA). Trifluoroacetic acid (TFA) was obtained from Riedel de Haen (Seelze, Germany).

Recombinant von Willebrand factor (rVWF)

Three non-commercial rVWF preparations were produced from Baxter Biosciences (Vienna, Austria). Sample A contained 0.67 mg/mL rVWF dissolved in a buffer system consisting of 5.25 g/L L-glycerin, 5.25 g/L L-lysine-hydrochloride, 5.25 g/L trisodium-citrate×2H₂O, 0.62 g/L CaCl₂×2H₂O and 2.2 g/L NaCl (pH 6.8). Sample B contained 0.49 mg/mL rVWF and sample C 0.54 mg/mL rVWF; both samples were dissolved in the following buffer system consisting of 20 mM HEPES, 150 mM NaCl and 0.5% saccharose (pH 7.4).

### Capillary Gel Electrophoresis-on-the-Chip for Evaluation of Sample Homogeneity

Prior to detailed characterization via nano ES GEMMA and MALDI TOF MS, the rVWF samples were investigated with CGE-on-the-chip, yielding a first overview of the three samples in terms of homogeneity and approximate molecular mass within a reasonable time span (60 seconds of separation time).

CGE-on-the-chip experiments were carried out using the 2100 Bioanalyzer and the Protein P200 plus assay (Agilent Technologies, Waldbronn, Germany) with a non-commercial set-up. The instrument was operated and the obtained results were integrated and evaluated with the aid of the 2100 Expert software v.B.02.02.51238.

All chips (Agilent Technologies, Waldbronn, Germany) were prepared according to the manufacturer's instruction. Briefly, 4 μL of the rVWF sample solutions were mixed with 2 μL of the provided denaturing solution containing 0.0052 mg/mL DTT, heated on 95° C. for 5 min and finally the mixture was diluted with 84 μL water. The final sample solution (6 μL) was applied into the designated sample wells on the CGE-chip and electrokinetically injected. For molecular mass determination a protein ladder consisting of well-defined proteins (provided in the Agilent Technologies kit) was treated in the same way.

### SDS-PAGE for Salt/Detergent Removal Optimization

For analysis of protein samples under reducing conditions 6 μL sample solution, 3 μL NuPage LDS sample buffer (4×) and 3 μL 0.1 M DTT were mixed, incubated for 1 min at 99° C. and cooled to room temperature. The resulting mixture (10 μL) was applied directly onto the slab gel. For molecular mass estimation the HiMark protein standard mixture was applied onto the gel additionally. A mixture containing 6 μL HiMark protein standard, 3 μL LDS sample buffer (4×) and 3 μL water were directly applied onto the gel. Electrophoresis was performed on a 3-8% Tris-Acetate, 1 mm×10 wells NuPage precast mini gel (Invitrogen, Carlsbad, Calif., USA) using freshly prepared Tris-Acetate SDS running buffer. Constant voltage was set to 150 V, after 70 min the separation was stopped. Directly after the separation the gel was placed in a fixing solution (45% MeOH, 5% acetic acid) for 30 min and subsequently stained with a Coomassie staining solution (0.1% CBB R250, 45% MeOH, 9% acetic acid) for 45 min. Finally, the gel was placed in a destaining solution (45% MeOH, 9% acetic acid) for 45 min, within this time frame the gel background became completely clear and distinct protein bands became visible.

### Sample Preparation Methods for Nano ES GEMMA Analysis

Due to the differing buffer compositions containing a high amount of salts, additives and detergents, the three rVWF samples were desalted/purified prior to application to the nano ES GEMMA device. Three different desalting approaches were evaluated, membrane centrifugation, size exclusion chromatography and dialysis. rVWF loss was monitored during these desalting/purifying procedure by SDS-PAGE.

For membrane centrifugation Nanosep™ centrifugal devices with a MW cut off of 3000 Da (Pall Corporation, Ann Arbor, Mich., USA) were used. rVWF sample solution (300 μL) was spun down 20 min at 5000 rpm, the residue was washed once with 20 mM ammonium acetate buffer (100 μL, pH 6.8) and re-suspended in 20 mM ammonium acetate buffer (300 μL, pH 6.8).

Size exclusion chromatography was performed with MicroSpin™ G-25 columns (GE Healthcare, Little Chalfont, UK). Due to the limitations of the MicroSpin™ column, the sample was split into two aliquots and desalted separately, twice for 2 min at 2000 rpm, each time using a new spin column. The aliquots were then recombined for GEMMA analysis.

Dialysis of rVWF preparations was performed in Slide-A-Lyzer® dialysis cassettes with a MW cut off of 10 kDa (Pierce, Rockford, Ill., USA). rVWF solution (300 μL) was diluted to a volume of 1.5 mL and dialyzed approximately 24 h in a dialysis solution (20 mM ammonium acetate, pH 6.8).

The rVWF samples were then reduced to break the disulfide bonds by mixing with 2% (w/v) SDS and 0.15% (w/v) DTT, incubation for 1 min at 99° C. The resulting reduced rVWF was then analyzed by GEMMA analysis.

### Nano ES GEMMA

The nano ES GEMMA system (TSI 3980) consists of a nano ES charge reduction unit (TSI 3480), a nano differential mobility analyzer (nDMA; TSI 3080) and an ultrafine condensation particle counter (μCPC; TSI 3025A) as detector (all parts from TSI Inc, Shoreview, Minn., USA). Multiply charged ions were generated by the nano electrospray unit and charge reduced by a bipolar atmosphere generated by means of polonium-210 to yield neutral and singly charged species. These species were size separated according to their electrophoretic mobility diameter (EMD) within a flow of particle-free air in the nDMA and detected with the μCPC.

For molecular mass determination of rVWF, the EMD of several well defined standard proteins were determined and correlated with their molecular mass. Based on the resulting relationship between EMD and molecular mass, the size of unknown molecules as the rVWF of this study were determined to provide the molecular mass^{34,37}.

The nano ES source was set at 2 kV spray voltage and 0.3 L/min CO₂ (99.995%, Air Liquide, Schwechat, Austria). Compressed air (generated by compressor type Hobby-Star 200 W, AGRE, Garsten-St. Ulrich, Austria, at 1 L/min) was applied to the instrument. A fused silica capillary with an inner diameter of 150 nm was used, and the tip of the spray needle was positioned at an angle of 75°. The ES ionization was operated in the positive ion mode. Ten to twenty scans (120 s per scan) across the whole size range were averaged for each final nano ES GEMMA spectrum presented herein.

### Sample Preparation for MALDI Mass Spectrometry

For reduction of the disulfide bonds in the rVWF dimers and multimers, a VWF solution (10 μL) was mixed with 10% LDS (w/v, 0.5 μL) and 1 M DTT (1 μL). The resulting mixture was vortexed thoroughly, spun down and incubated at 99° C. for 1 min. Afterwards, sample desalting/purification was performed with ZipTip™ pipette tips containing a hydrophilic HPL resin (Millipore, Bedford, Mass., USA). Then, 10 μL solution A (ACN/0.1% FA, 9:1, v/v) was mixed with the sample solution. For wetting the HPL stationary phase, 10 μL of solution B (ACN, 0.1% FA, 1:1, v/v) was aspirated and dispensed to waste. Equilibration of the resin was obtained by aspirating and dispensing solution A three times. The sample was bound to the resin by aspirating and dispensing the sample solution seven times. To remove all interfering salts, additives and detergents the tip was washed with plain solution A ten times. Then, the VWF was eluted with 2 to 4 μL MALDI matrix solution (10 mg THAP dissolved in 1 mL 0.1% TFA/ACN (1:1, v/v) solution). For MALDI MS analysis 0.5 μL of the resulting sample/matrix solution were applied onto the stainless steel MALDI target. Calibration was performed externally by using the Invitromass high molecular weight mass calibration kit. The calibration kit was applied according to the manufacturer's instructions.

### MALDI Mass Spectrometry

All MALDI TOF MS experiments were carried out on an AXIMA TOF² (Shimadzu Biotech Kratos Analytical, Manchester, UK) equipped with a nitrogen laser (λ=337 nm). The instrument was operated in positive ion, linear mode without using pulsed extraction. Each mass spectrum was acquired by averaging 50 to 200 unselected and consecutive laser shots. Prior to data analysis the mass spectra were smoothed with Savitsky-Golay algorithm.

### Results

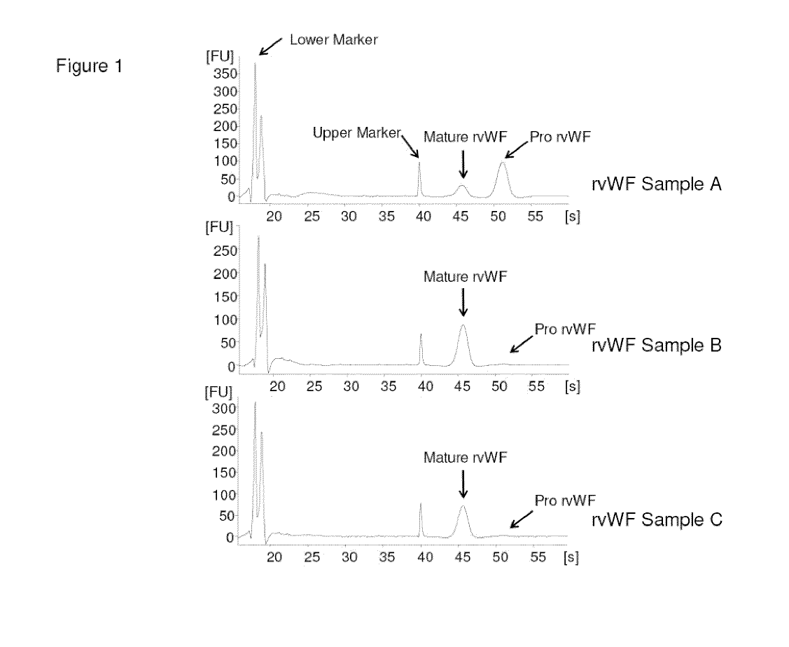

The homogeneity of the rVWF samples was measured using CGE-on-the-chip. Without any particular sample preparation and within a short time span (60 sec run time) data of rVWF samples A, B and C (FIG. 1) were obtained, revealing that each sample had two peaks corresponding to two different rVWF species. They were determined to be mature rVWF, having a molecular mass of 277 kDa, and pro-rVWF, having a molecular mass of 341 kDa. The presence of the pro-rVWF was rationalized as due to incomplete enzymatic cleavage to the mature rVWF. The major component of Sample A was pro-rVWF with some mature rVWF (see FIG. 1, top). The analyses of Samples B and C showed that mature rVWF was the major component, with little pro-rVWF.

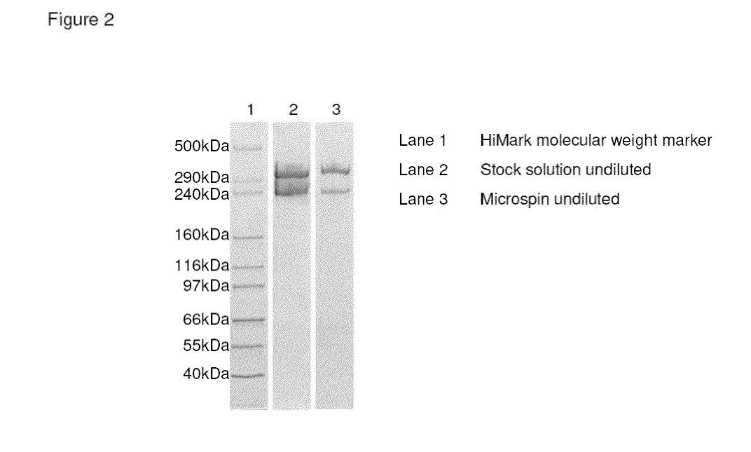

Three different desalting procedures were assessed to remove salts and detergents from the rVWF samples prior to GEMMA analysis: membrane centrifugation (Nanosep™ 3K), size exclusion chromatography (MicroSpin™ G-25), and dialysis (Slide-A-Lyzer® 10K). Glycoprotein recovery after the desalting procedure was monitored with SDS-PAGE under reducing conditions. FIG. 2 shows the SDS-PAGE data comparing rVWF sample A without desalting (lane 2) and desalted two times with Microspin™ G-25 (size exclusion chromatography) columns (lane 3). Untreated rVWF sample A shows two protein bands at approximately 269 kDa and 339 kDa, confirming the data achieved by CGE-on-the-chip. Size exclusion chromatography (MicroSpin™ G-25) of rVWF sample A also yielded two distinct protein bands, slightly fainter than the protein bands obtained from the untreated sample. Dialysis of rVWF samples resulted in extensive sample loss, most likely caused by adsorption of the highly adhesive rVWF to the dialysis membrane. There was little analyte lost when the sample was desalted using membrane centrifugation (Nanosep™ 3K).

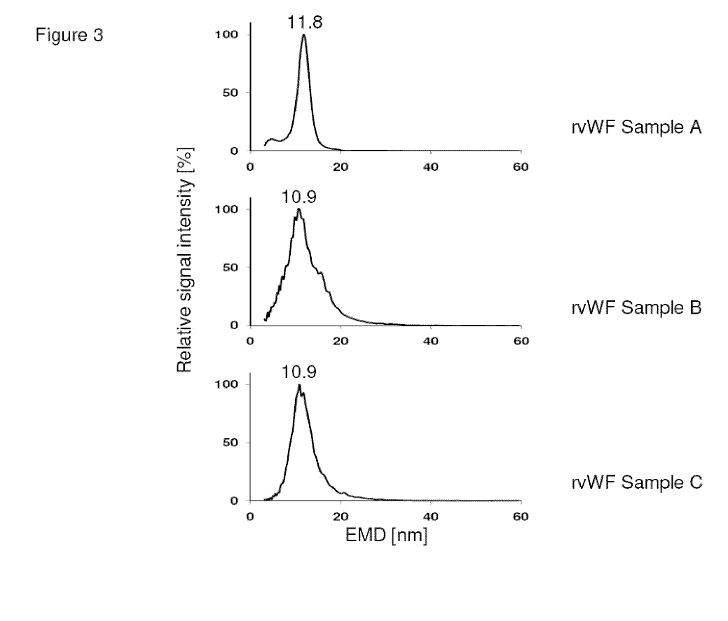

FIG. 3 shows nano ES GEMMA spectra of reduced rVWF samples A to C having different rVWF concentrations. GEMMA spectra of rVWF sample A (FIG. 3, top) shows an intense peak at 11.9 nm (±1.6%) corresponding to a molecular mass of 298.8 kDa, whereas rVWF sample B (FIG. 3, center) and C (FIG. 3, bottom) show peaks at 10.9 nm, corresponding to a molecular mass of 227 kDa (±2.5%).

The resolution of the nDMA used was not sufficient to clearly separate both molecular ions for the mature and pro-rVWF. In fact, the peak at 11.8 nm was the average value between 10.9 nm (measured from sample B and C) and 12.7 nm (the base for this value were MALDI TOF data). Samples B and C contain mostly mature and little pro-rVWF, which was confirmed by their nano ES GEMMA spectra. The concentration of the pro-rVWF was negligible, which corroborates the CGE-on-the-chip data.

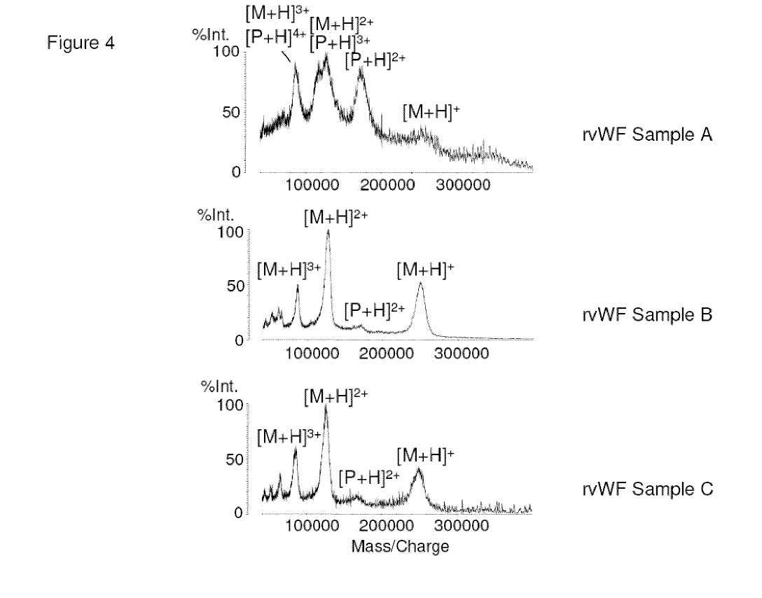

The rVWF samples were also analyzed by MALDI TOF MS. Due to its tolerance to salts and detergents, no extensive sample desalting/purification was needed. After reduction of disulfide bonds to obtain the rVWF monomer, salts and detergents were removed by a ZipTip™ desalting approach. FIG. 4 shows the positive ion MALDI mass spectra of rVWF samples A to C after the desalting step. The MALDI-TOF spectra showed several ionized species of rVWF: [M+H]⁺ (m/z 256100), [M+2H]²⁺ (m/z 127800) and [M+3H]³⁺ (m/z 87600) ions of mature rVWF and [P+2H]²⁺ (m/z 174400), [P+3H]³⁺ (m/z 118100) and [P+4H]⁴⁺ (m/z 87600) ions of pro-rVWF were detected in the positive ion mass spectrum of rVWF sample A (see FIG. 4, top). A singly charged molecular ion of pro-rVWF was not detected.

Doubly charged mature rVWF (m/z 127800) and triply charged pro-rVWF species (m/z 118100) are not easily resolved or separated due to low MS resolution, resulting in a broad signal with two maxima. Separation of triply charged mature and quadruply charged pro-rVWF species was not observed, as the m/z values are indistinguishable (m/z 87000). MALDI mass spectra of rVWF sample B and C (FIG. 4, center and bottom) containing mainly mature rVWF (confirmed by CGE-on-the-chip analysis, FIG. 1) and small amounts of pro-rVWF, showed singly (m/z 249000), doubly (m/z 125600) and triply (m/z 85600) charged molecular ions of mature rVWF with excellent S/N ratios. These MALDI mass spectra also detected the doubly charged molecular ion of pro-rVWF (m/z 169300 sample B and m/z 167200 sample C) could be detected, in small amounts.

Table 1 summarizes molecular mass data obtained by nano ES GEMMA, MALDI TOF MS and CGE-on-the-chip. By means of external mass calibration of the MALDI TOF mass spectrometer, molecular mass determination of rVWF species was possible with a precision of ±0.8%. The experimental molecular mass values and calculated values based on the amino acid sequence of VWF^{38,3} were within a Δm of 27 to 43 kDa for pro-rVWF and a Δm of 30 to 34 kDa for mature rVWF. These Δm values can be attributed to the carbohydrate moiety of the rVWF, indicating a glycosylation degree of 8 to 12% for pro-rVWF and 12 to 14% for mature rVWF.

Separation of the mature and pro-rVWF in sample A was not observed for the nanoES GEMMA analysis. Due to the lower resolution, a mixture of both species was detected at 11.9 nm, corresponding to a molecular mass of 298.8 kDa (±1.6%). Back-calculation from the MALDI MS data, 256.1 kDa (mature rVWF) and 349.8 kDa (pro-rVWF) indicated an EMD of 11.3 nm and 12.6 nm, respectively. Samples B and C had only low amounts of pro-rVWF, and only mature rVWF species was detected in their nano ES GEMMA analyses, which corresponded to a molecular mass of 227.4 kDa (±2.5%).

TABLE 1

| | Nano ES | | MALDI | | CGE-on- | |
|---|---|---|---|---|---|---|
| | GEMMA | | TOF MS | | the-chip | |
| Sample | Mature | Pro | Mature | Pro | Mature | Pro |
| A | 298.8¹ | | 256.1 | 349.8 | 277.8 | 341.9 |
| B | 227.4 | — | 249.1 | 338.6 | 277.2 | 342.5 |
| C | 227.4 | — | 248.9 | 334.6 | 276.5 | 341.3 |

External MS mass calibration provided information about the molecular mass of the rVWF, which compared to reported values. Reported values were about 226 kDa for mature and about 307 kDa for pro-rVWF and MALDI TOF MS values were 256.1 kDa (±0.8%) for mature rVWF and 349.8 kDa (±0.8%) for pro-rVWF. Mass differences of 30 to 34 kDa (mature rVWF) and 27 to 43 kDa were obtained, which can be related to the 22 N- and O-glycans of rVWF, indicating a glycosylation degree of 12 to 14% for mature and of 8 to 12% for pro-rVWF. Nano ES GEMMA analysis of rVWF sample A showed a size of 11.9, indicated a molecular mass of 298.8 kDa (±1.6%), which was actually a mixture of the mature rVWF and pro-rVWF. Nano ES GEMMA analysis of rVWF samples B and C having low amounts of pro-rVWF resulted in detection of the mature rVWF with a molecular mass of 227.4 kDa (±2.5%), corresponding to a size of 10.9 nm.

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

### REFERENCES

1. Ruggeri Z M, Zimmerman TS. Blood 1987; 70: 895
2. Sadler J E. The Journal of Biological Chemistry 1991; 266: 22777
3. Dent J A, et al. Journal of Clinical Investigation 1991; 88: 774
4. Ruggeri Z M. Current Opinion in Hematology 2003; 10: 142
5. Furlan M. Annals of Hematology 1996; 72: 341
6. Jaffe E A, et al. Journal of Clinical Investigation 1973; 52: 2757
7. Wagner D D, et al. Journal of Cell Biology 1984; 99: 2123
8. Nachman R, et al. Journal of Clinical Investigation 1977; 60: 914
9. Titani K, et al. Biochemistry 1986; 25: 3171
10. Marti T, et al. Biochemistry 1987; 26: 8099
11. Wagner D D, et al. Blood 1987; 69: 27
12. Sodetz J M, et al. The Journal of Biological Chemistry 1979; 254: 10754
13. Matsui T, et al. The Journal of Biological Chemistry 1992; 267: 8723
14. Millar C M, et al. Blood Reviews 2006; 20: 83
15. Carew J A, et al. Blood 1990; 76: 2530
16. Dent J A, et al. Proceedings of the National Academy of Sciences of the United States of America 1990; 87: 6306
17. Carew J A, et al. Journal of Clinical Investigation 1992; 90: 2258
18. van Schooten C J, et al. Blood 2007; 109: 2430
19. Wagner D D, et al. Journal of Cell Biology 1982; 95: 355
20. Ruggeri Z M. Journal of Thrombosis and Haemostasis 2003; 1: 1335
21. Vlot A J, et al. Thrombosis and Haemostasis 1998; 79: 456
22. Budde U, et al. Reviews in Clinical and Experimental Hematology 2001; 5: 335
23. Federici A B. Haemophilia 2008; 14 Suppl 1: 5
24. Menache D, et al. Thrombosis and Haemostasis 1997; 78: 566
25. Thompson A R. Haematologica Reports 2005; 1: 32
26. Mannuccio P M, et al. Blood 1994; 83: 3018
27. Fischer B E. Journal of Thrombosis and Thrombolysis 1999; 8: 197
28. Turecek P L, et al. Histochemistry and cell biology 2002; 117: 123
29. Rand J H, et al. British journal of haematology 1987; 67: 433
30. Fischer B, et al. FEBS Letters 1994; 351: 345
31. Kaufman S L, et al. Analytical Chemistry 1996; 68: 1895
32. Koropchak J A, et al. Analytical Chemistry 1999; 71: 386A
33. Kaddis C S, et al. Analytical Chemistry 2007; 79: 1778
34. Bacher G, et al. Journal of Mass Spectrometry 2001; 36: 1038
35. Muller R, et al. Rapid Communication in Mass Spectrometry 2006; 20: 3803
36. Karas M, et al. Analytical Chemistry 1988; 60: 2299
37. Laschober C, et al. Journal of Experimental Nanosciences 2007; 2: 291
38. http://www.expasy.org/uniprot/P04275 (May 2008)
39. Müller R, et al, Analytical and Bioanalytical Chemistry 2007; 389: 1859

What is claimed:

1. A method for external and internal calibration of a MALDI mass spectrum for determining molecular weight of a high molecular weight analyte, comprising
a) obtaining a mass spectrum of a recombinant von Willebrand Factor (rVWF) of known molecular weight;
b) analyzing an analyte via mass spectrometry to provide a mass spectrum, wherein the analyte has a molecular weight of at least 500 kDa; and
c) determining the molecular weight of the analyte by correlating the mass spectrum of the analyte to the mass spectrum of the rVWF.

2. The method of claim 1, wherein the analyte has a molecular weight of at least 1000 kDa.

3. The method of claim 2, wherein the analyte has a molecular weight of at least 1500 kDa.

4. The method of claim 1, wherein the analyte comprises an protein larger than 200 kD

5. The method of claim 1, wherein the analyte comprises an immunoglobulin, a fibrinogen, a fibronectin, or a factor XIII,

6. The method of claim 1, wherein the mass spectrometry comprises matrix-assisted laser desorption ionization (MALDI) or matrix-assisted laser desorption ionization-time of flight (MALDI-TOF).

7. The method of claim 1, further comprising desalting the analyte prior to analyzing.

8. The method of claim 1, further comprising calculating the rVWF molecular weight by determining the number of monomers of VWF (SEQ ID NO: 1) in the rVWF.

9. The method of claim 8, wherein the monomers of VWF are connected by disulfide bonds.
